(19) United States
(12) Patent Application Publication
(10) Pub. No.: US 2018/0030864 A1
(43) Pub. Date: Feb. 1, 2018

(54) Crankshaft Having an Oil Groove

(71) Applicant: Bayerische Motoren Werke Aktiengesellschaft, Muenchen (DE)

(72) Inventor: Ulrich GUTZER, Muenchen (DE)

(21) Appl. No.: 15/729,213

(22) Filed: Oct. 10, 2017

Related U.S. Application Data
(63) Continuation of application No. PCT/EP2016/065891, filed on Jul. 6, 2016.

(30) Foreign Application Priority Data
Aug. 14, 2015 (DE) 10 2015 215 519.6

(51) Int. Cl. F01M 1/06; F16C 3/14

(52) U.S. Cl. CPC F01M 1/06; F16C 3/14; F01M 2001/062

(57) ABSTRACT

A crankshaft has a rotational axis, about which the crankshaft can be rotated, and a crankpin journal for mounting a connecting rod eye of a connecting rod. A groove runs in the circumferential direction of the crankpin journal and is provided for the supply of lubricating oil in an outer surface of the crankpin journal. The groove extends only over a defined part length of the circumference of the crankpin journal. A crank arrangement includes a crankshaft of this type and a bearing shell which engages around the crankpin journal.

### CROSS REFERENCE TO RELATED APPLICATIONS

This application is a continuation of PCT International Application No. PCT/EP2016/065891, filed Jul. 6, 2016, which claims priority under 35 U.S.C. § 119 from German Patent Application No. 10 2015 215 519.6, filed Aug. 14, 2015, the entire disclosures of which are herein expressly incorporated by reference.

### BACKGROUND AND SUMMARY OF THE INVENTION

The invention concerns a crankshaft with an axis of rotation about which the crankshaft rotates, and a crankpin for the mounting of a connecting rod eye of a connecting rod. The invention also concerns a crank arrangement having a crankshaft of this type.

A crankshaft usually has shaft journals which are arranged along an axis of rotation of the crankshaft. Crankpins are provided, being set off from the shaft journals and joined to them by crank webs. The crankpins each mount a connecting rod eye of a connecting rod. Moreover, it is known to arrange, between connecting rod eye and crankpin, an eccentric, rotating bearing shell in order to allow a variable compression of an internal combustion engine, e.g., by adjusting the phase angle of the eccentric bearing shell. Such a crank arrangement is known, for example, from EP 0 184 042 A2.

In the case of such a rotating bearing shell, both the sliding surface at the crankpin side and the sliding surface at the connecting rod side must be supplied with lubricating oil. This is accomplished through radial bores through the bearing shell, wherein an encircling groove is to be provided in the circumferential direction in the bearing shell at the crankpin side so that the radial bores receive a continual oil supply from the crankshaft for all phase angles of the eccentric bearing shell.

This groove in the case of a rotatable bearing shell weakens the carrying capacity of the connecting rod bearing at the crankshaft side.

The invention seeks to solve this problem at least in part. This problem is solved by a crankshaft with an axis of rotation about which the crankshaft rotates, and a crankpin for the mounting of a connecting rod eye of a connecting rod. A groove for lubricating oil supply is provided in an outer surface of the crankpin. The groove runs in the circumferential direction of the crankpin and extends only across a defined partial length of the circumference of the crankpin. The problem is further solved by a crank arrangement having such a crankshaft.

According to one exemplary embodiment of the invention, a crankshaft is provided having an axis of rotation about which the crankshaft can rotate, and a crankpin for the mounting of a connecting rod eye of a connecting rod. A groove for lubricating oil supply is provided in an outer surface of the crankpin, running in the circumferential direction of the crankpin and extending only across a defined partial length of the circumference of the crankpin. This embodiment has distinct advantages over the prior art. Since the crankpin itself does not rotate about its own center line, the groove can be arranged specifically at a location which is favorable from a loading standpoint in regard to the top dead center (TDC) position. This is not possible if an oil groove is made in the bearing shell, since the groove would then have to completely encircle the circumference of the bearing shell on account of the rotatability of the bearing shell, which reduces the strength of the bearing shell and thus that of the bearing.

According to another embodiment of the invention, the crankshaft additionally has a shaft journal through which the axis of rotation of the crankshaft extends; a crank web, which joins the shaft journal to the crankpin; and an oil supply duct. This oil supply duct extends through the shaft journal, the crank web and the crankpin and empties into the groove. By way of the oil supply duct, the groove for lubricating oil supply of the shaft journal is supplied with oil, which in turn is supplied as usual via the bearing of the shaft journal from the crank housing.

According to another embodiment of the invention, the crankshaft has an imaginary plane, containing the axis of rotation and a center line of the crankpin around which the outer surface of the crankpin extends. The imaginary plane intersects the outer surface of the crankpin facing away from the axis of rotation along a TDC line, with a larger portion of the groove lying on that side of the TDC line running ahead of the crankshaft during operation.

According to another embodiment of the invention, the crankshaft moreover has an imaginary plane containing the axis of rotation and a center line of the crankpin around which the outer surface of the crankpin extends. The imaginary plane intersects the outer surface of the crankpin facing away from the axis of rotation along a TDC line, wherein the groove is arranged entirely only within a circumferential segment of the outer surface of the crankpin which extends 180° around the center line away from the TDC line on the side running ahead during operation and 10° around the center line away from the TDC line in the opposite direction.

Preferably, the circumferential segment extends 120° around the center line away from the TDC line on the side running ahead during operation and 5° around the center line away from the TDC line in the opposite direction.

More preferably, the circumferential segment extends 90° around the center line away from the TDC line on the side running ahead during operation and 5° around the center line away from the TDC line in the opposite direction.

Even more preferably, the circumferential segment extends from the TDC line up to 90° around the center line away from the TDC line on the side running ahead during operation.

Furthermore, the invention concerns a crank arrangement with a crankshaft according to one of the preceding embodiments and a bearing shell which engages around the crankpin. With this embodiment, the same advantages can be achieved as were described in connection with the crankshaft.

According to one embodiment of the invention, an outer surface of the bearing shell is eccentric to an inner surface of the bearing shell which slides on the crankpin.

According to another embodiment of the invention, the oil ducts extend from an inner surface of the bearing shell to an outer surface of the bearing shell.

According to yet another embodiment of the invention, the overwhelming majority of oil ducts of a bearing shell extend in a direction which is not parallel to a radial direction with respect to an inner surface of the bearing shell.

Furthermore, the invention concerns a vehicle with such a crankshaft or such a crank arrangement.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic front view of a portion of a crankshaft according to an exemplary embodiment of the invention.

FIG. 2 is a schematic side view of a crank arrangement with the crankshaft of FIG. 1.

### DETAILED DESCRIPTION OF THE DRAWINGS

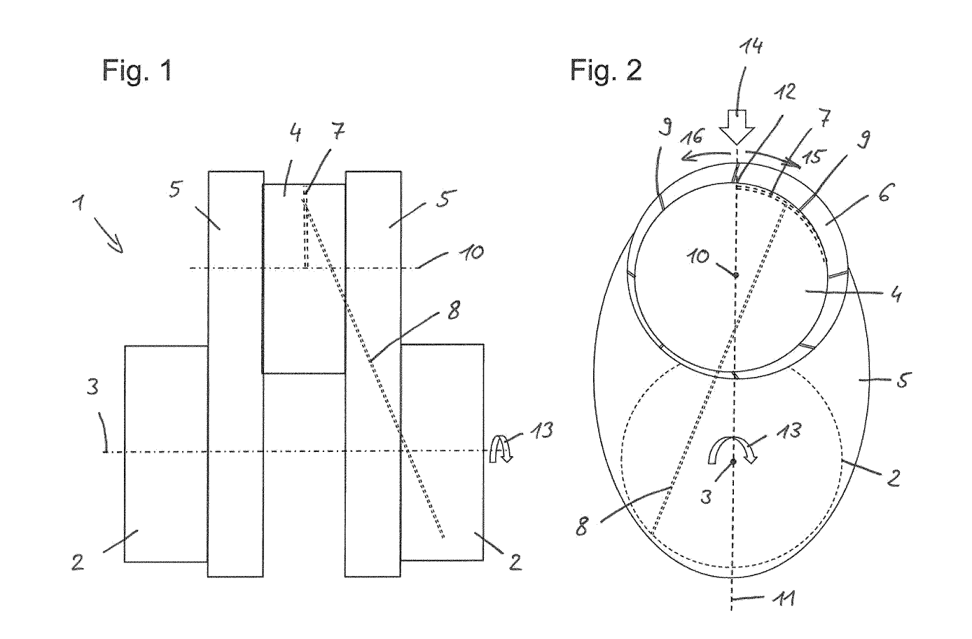

FIG. 1 is a schematic front view of a portion of a crankshaft 1 according to an exemplary embodiment of the invention. The crankshaft 1 includes shaft journals 2 which are cylindrical and whose center axis lies on an axis of rotation 3 of the crankshaft 1. In the installed state, the crankshaft 1 is mounted so that it can rotate about the rotational axis 3. Crankpins 4 (also known as crank journals or crankpin journals) are provided which are set off from the shaft journals 2. The crankpins 4 are joined to the shaft journals 2 by crank webs 5. The crankpins 4 are cylindrical, wherein their center axes 10 run parallel to the axis of rotation 3. FIG. 1 shows only two shaft journals 2 and only one crankpin 4, although of course a crankshaft 1 generally has several shaft journals 2 and several crankpins 4. The number of crankpins 4 corresponds to the number of cylinders which interact with the crankshaft 1.

FIG. 2 is a schematic side view of a crank arrangement with the crankshaft 1 of FIG. 1. FIG. 2 additionally shows a bearing shell 6 which engages around the crankpin 4. An inner surface (i.e., the surface pointing radially inward to the center line 10 of the crankpin) of the bearing shell 6 slides on an outer surface of the crankpin 4 and forms a bearing at the crankpin side. An outer surface (i.e., the surface pointing radially outward away from the center line 10 of the crankpin) of the bearing shell 4 slides on an inner surface of a connecting rod eye of a connecting rod (not shown) and forms a bearing at the connecting rod side. The bearing shell 6 is eccentric in design, i.e., a center axis of the inner surface is set off from a center axis of the outer surface. Thanks to this eccentric bearing shell 6, the compression of the internal combustion engine can be varied, as is known in the prior art.

According to the invention, a groove 7 is provided to supply the bearing at the connecting rod side and the bearing at the crankpin side with lubricating oil. By way of the groove 7, the bearing shell 6 is optimally lubricated always before reaching the top dead center (TDC) position where the ignition of the associated cylinder occurs.

More precisely, oil is delivered by the rotation of the crankshaft 1, via an oil supply duct 8 which extends through the shaft journals 2, the crank webs 5 and the crankpins 4, from the opening of the oil supply duct 8 at the shaft journal side to the groove 7. From the groove 7, the oil is distributed along the bearing at the crankpin side (i.e., between crankpin 4 and bearing shell 6) and along the bearing at the connecting rod side (i.e., between connecting rod, or more precisely the inside of the connecting rod eye and the bearing shell). From the inside of the bearing shell 6, oil is delivered via oil ducts 9 to the outside.

According to the invention, the groove 7 is formed in the outer surface of the crankpin 4. The groove 7 runs in the circumferential direction (around the center line 10 of the crankpin 4), especially on a circular trajectory about the center line of the crankpin 4. The groove 7 does not describe a complete circle, i.e., it does not extend over the entire circumference, but rather only along a partial length of the circumference of the crankpin 4. This has the advantage that the crankpin 4 is weakened as little as possible by the groove and the oil for lubrication is transported specifically to an optimal site. The groove 7 lies at a site with less loading of the bearing, since upon reaching the maximum cylinder pressure it is already rotated away from the load direction.

In operation, the crankshaft rotates about the axis of rotation 3 in a direction indicated by the arrow 13. The crankpin 4 likewise rotates about the axis of rotation 3 in the same direction. The bearing shell 6 turns about the center line 10, for example, with half the velocity of the crankshaft 1 about the axis of rotation 3. This turning is effected by gear mechanisms (not represented here and not the subject matter of this invention). The relative motion between bearing shell 6 and crankpin 4 results in oil being distributed from the groove 7 in FIG. 2 in the opposite direction of the rotational direction 13. Thus, upon reaching the top dead center 14, the bearing is optimally lubricated. In order to accomplish this, the groove 7 is arranged as follows.

FIG. 2 shows an imaginary plane 11 which contains the axis of rotation 3 and the center line 10. This plane 11 intersects the outer surface of the crankpin 4 facing away from the axis of rotation 3 along a TDC line 12. Preferably, the groove 7 is located entirely within a circumferential segment, i.e., the groove 7 does not extend outside of this circumferential segment.

The circumferential segment extends preferably, on the one hand, 180° around the center line 10 away from the TDC line 12 on the side 15 of the outer surface running ahead during operation and, on the other hand, 10° around the center line 10 away from the TDC line in the opposite direction 16.

Preferably, the circumferential segment extends 120° around the center line 10 away from the TDC line 12 on the side 15 running ahead during operation and 5° around the center line 10 away from the TDC line 12 in the opposite direction 16.

More preferably, the circumferential segment extends 90° around the center line 10 away from the TDC line 12 on the side 15 running ahead during operation and 5° around the center line 10 away from the TDC line 12 in the opposite direction 16.

Even more preferably, the circumferential segment extends from the TDC line 12 up to 90° around the center line 10 away from the TDC line on the side 15 running ahead during operation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A crankshaft having an axis of rotation about which the crankshaft rotates, comprising:
a crankpin for mounting a connecting rod eye of a connecting rod; and
a groove provided in an outer surface of the crankpin and running in a circumferential direction of the crankpin, wherein
the groove supplies lubricating oil and extends only over a defined partial length of a circumference of the crankpin.

2. The crankshaft as claimed in claim 1, further comprising:
a shaft journal through which the axis of rotation of the crankshaft extends;
a crank web, which joins the shaft journal to the crankpin; and
an oil supply duct, which extends through the shaft journal, the crank web and the crankpin and empties into the groove.

3. The crankshaft as claimed in claim 1, wherein
the crankshaft is configured such that there is an imaginary plane, containing the axis of rotation and a center line of the crankpin around which the outer surface of the crankpin extends, wherein
the imaginary plane intersects the outer surface of the crankpin facing away from the axis of rotation along a TDC line, and
a larger portion of the groove lies on that side of the TDC line that runs ahead of the crankshaft during operation.

4. The crankshaft as claimed in claim 1, wherein
the crankshaft is configured such that there is an imaginary plane containing the axis of rotation and a center line of the crankpin around which the outer surface of the crankpin extends, wherein
the imaginary plane intersects the outer surface of the crankpin facing away from the axis of rotation along a TDC line, and
the groove is arranged entirely only within a circumferential segment of the outer surface of the crankpin which extends 180° around the center line away from the TDC line on the side running ahead during operation and 10° around the center line away from the TDC line in the opposite direction.

5. A crank arrangement, comprising:
a crankshaft as claimed in claim 1; and
a bearing shell which engages around the crankpin.

6. The crank arrangement as claimed in claim 5, wherein
an outer surface of the bearing shell is eccentric to an inner surface of the bearing shell, which inner surface slides on the crankpin.

7. The crank arrangement as claimed in claim 5, further comprising:
oil ducts of the bearing shell, which oil ducts extend from an inner surface of the bearing shell to an outer surface of the bearing shell.

8. The crank arrangement as claimed in claim 7, wherein
a majority of the oil ducts of the bearing shell extend in a direction which is not parallel to a radial direction with respect to an inner surface of the bearing shell.

9. A motor vehicle comprising a crank arrangement as claimed in claim 5.
